(19) United States
(12) Patent Application Publication
(10) Pub. No.: US 2001/0048990 A1
(43) Pub. Date: Dec. 6, 2001

(54) Image forming apparatus, intermediate image transfer belt therefor and method of producing the belt

(75) Inventor: Sadayuki Iwai, Kanagawa (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Ricoh Company, Ltd., Ohta-ku (JP)

(21) Appl. No.: 09/820,844

(22) Filed: Mar. 30, 2001

(30) Foreign Application Priority Data
Mar. 31, 2000 (JP) 2000-096421

(51) Int. Cl. B32B 3/00; B65D 1/00; F16L 1/00; B32B 1/08; B29D 22/00; B29D 23/00

(52) U.S. Cl. 428/36.8; 428/36.91

(57) ABSTRACT

An intermediate image transfer belt for an image forming apparatus of the present invention includes at least a surface layer and a base layer. To produce the belt, while a hollow, cylindrical mold included in a centrifugal molding machine is in rotation, thermosetting urethane rubber is fed into the mold and then cured to form the surface layer on the inside of the mold. Subsequently, thermosetting urethane resin is fed into the mold and then cured to form the base layer on the surface layer. The surface layer is elastic and can closely contact the surface of, e.g., a plain paper sheet lacking smoothness. The belt therefore insures desirable image transfer.

### BACKGROUND OF THE INVENTION

The present invention relates to a copier, facsimile apparatus, printer or similar electrophotographic image forming apparatus and more particularly to an intermediate image transfer belt therefor and a method of producing the belt.

An image forming apparatus of the type using a developing liquid is extensively used. This type of image forming apparatus includes a developing device storing the developing liquid and an intermediate image transfer body. The developing device develops a latent image formed on a photoconductive element, or image carrier, with charged toner particles contained in the developing liquid. The developing liquid is a viscous liquid whose toner content is relatively high. An image forming apparatus of the type using a dry, powdery developer or toner and an intermediate image transfer body is also conventional.

Usually, in the image forming apparatus of any one of the types described, toner images are sequentially formed on an image forming apparatus while being sequentially transferred to an endless, intermediate image transfer belt, which is a specific form of the intermediate image transfer body, one above the other (primary image transfer). The resulting composite toner image is collectively transferred from the belt to a paper sheet or similar recording medium (secondary image transfer).

To produce the intermediate image transfer belt, it has been customary to feed a thermoplastic material into a centrifugal molding machine or to feed resin into an injection molding machine. The belt is directly used as an intermediate image transfer belt or wrapped around a drum to constitute an intermediate image transfer drum. So long as a coated paper sheet or similar recording medium having a smooth surface is used, such an intermediate image transfer body can effect desirable secondary image transfer to thereby insure high-quality images.

However, the conventional intermediate image transfer body is not desirable when use is made of a plain paper sheet whose surface lacks smoothness. Specifically, the surface of a plain paper sheet is not fully smooth, but has cavities that are generally several ten micrometers deep. Consequently, toner simply deposits on the projections of fibers constituting the plain paper sheet, but does not enter the cavities, resulting in defective secondary image transfer and therefore irregular image density. This prevents the hard surface of the intermediate image transfer body, which is formed of the thermoplastic material or the resin, from accurately following the surface configuration of the image transfer body, thereby rendering secondary image transfer defective.

In light of the above, there has been proposed an intermediate image transfer body having an elastic surface formed of rubber. A belt formed of rubber, however, causes an image present on the belt to extend or contract due to the variation of tension applied to the belt. As a result, image components expected to form a composite color image in combination are shifted from each other.

### SUMMARY OF THE INVENTION

It is therefore an object of the present invention to provide an intermediate image transfer belt capable of desirably transferring a toner image even to a plain paper sheet or similar recording medium whose surface lacks smoothness, and a method of producing the same.

It is another object of the present invention to provide an image forming apparatus using the above-described intermediate image transfer belt and insuring stable image quality.

In accordance with the present invention, a method of producing an intermediate image transfer belt is applicable to an image forming apparatus that includes an image carrier for forming a latent image, a developing device for developing the latent image with a developer to thereby form a corresponding toner image, and the intermediate image transfer belt to which the toner image is transferred from the image carrier. The apparatus executes primary image transfer from the image carrier to the intermediate image transfer belt and then executes secondary image transfer from the intermediate image transfer belt to a recording medium. The method begins with a step of feeding a first raw liquid material into a hollow, cylindrical mold, which is included in a centrifugal molding machine, while causing the mold to rotate. The first raw material is cured to thereby form a first endless belt layer on the inside of the mold. Subsequently, a second raw liquid material is fed into the mold with the mold being rotated. The said second raw liquid is cured to thereby form a second belt layer. The first belt layer has elasticity while the second belt layer has greater hardness than the first belt layer.

An intermediate image transfer belt produced by the above procedure and an image forming apparatus including the same are also disclosed.

### BRIEF DESCRIPTION OF THE DRAWINGS

The above and other objects, features and advantages of the present invention will become more apparent from the following detailed description taken with the accompanying drawings in which:

FIGS. 1A through 1C are views demonstrating image transfer from a conventional intermediate image transfer belt to a plain paper sheet lacking surface smoothness;

FIG. 2 is a view showing essential part of an image forming apparatus embodying the present invention;

FIGS. 3A through 3C are views demonstrating image transfer from an intermediate image transfer belt included in the illustrative embodiment to a plain paper sheet;

FIG. 4 is a view showing a centrifugal molding machine applicable to the illustrative embodiment;

FIG. 5 is a side elevation of the intermediate image transfer belt produced by the centrifugal molding machine; and

FIG. 6 is a table listing the results of experiments conducted to determined a relation between the thickness of a surface layer (rubber layer) included in an intermediate image transfer belt and estimation factors including an image transfer characteristic.

### DESCRIPTION OF THE PREFERRED EMBODIMENT

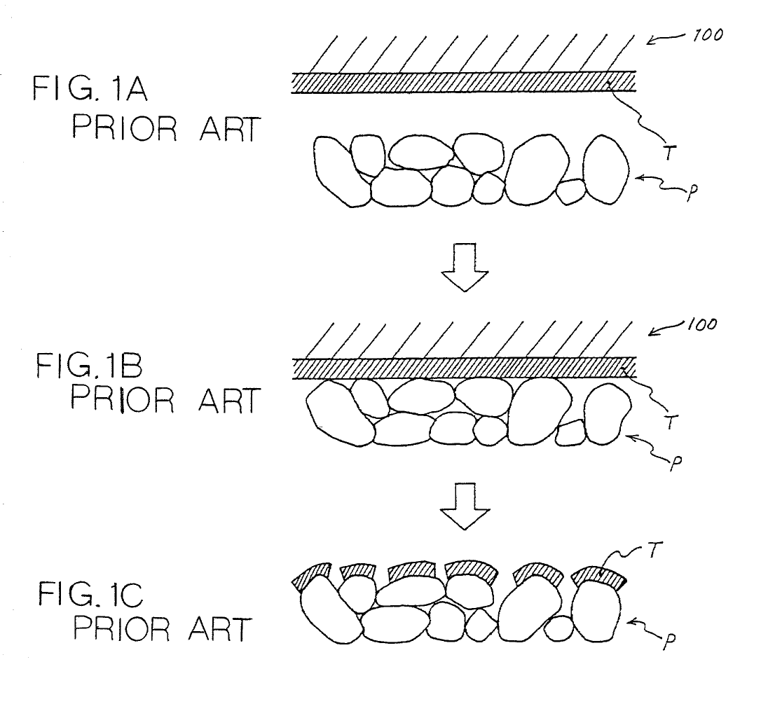

To better understand the present invention, the problem with the conventional intermediate image transfer body will be described more specifically with reference to FIGS. 1A through 1B.

With the intermediate image transfer body, it is possible to effect desirable secondary image transfer and therefore to produce high-quality images so long as use is made of coated paper sheet or similar recording medium having a smooth surface, as stated earlier. However, as shown in FIG. 1A, a plain paper sheet P has a surface that is not fully smooth, but includes cavities that are several ten micrometers deep. The maximum depth of such cavities is, e.g., about 30 micrometers.

Assume that an intermediate image transfer body 100 shown in FIG. 1A has a hard surface. Then, as shown in FIG. 1B, it is difficult for the surface of the intermediate image transfer body 100 to follow the cavities of the paper sheet P. Consequently, as shown in FIG. 1C, toner T simply deposits on the projections of fibers constituting the paper sheet P, but does not enter the cavities, resulting in defective secondary image transfer.

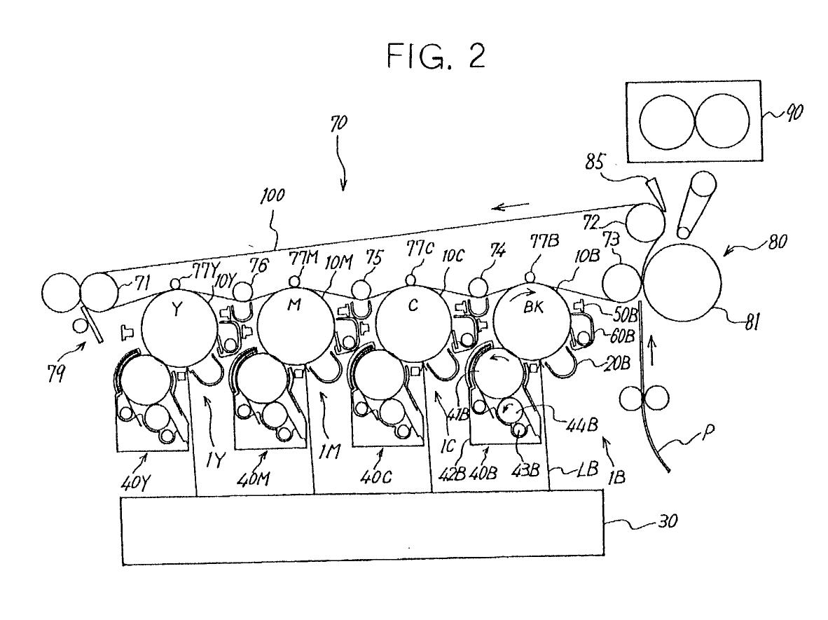

Referring to FIG. 2, an image forming apparatus embodying the present invention is shown and implemented as an electrophotographic, tandem copier using a developing liquid by way of example. As shown, the tandem copier includes four image forming sections 1Y (yellow), 1M (magenta), 1C (cyan) and 1B (black), an intermediate image transferring unit 70, an image transferring device 80, and a fixing device 90. The copier additionally includes an image scanning section, a paper feeding section, and a control section although not shown specifically.

The image forming section 1Y includes a photoconductive drum 10Y and a developing device 40Y, which stores yellow toner. Likewise, the image forming sections 1M, 1C and 1B respectively include photoconductive drums 10M, 10C and 10B and developing devices 40M, 40C and 40B, which store magenta toner, cyan toner and black toner, respectively. The drums 10Y through 10B each are scanned imagewise in accordance with image data of a particular color, so that a full-color image can be formed. Because the four image forming sections 1Y through 1B are identical in configuration with each other, let the following description concentrate on the image forming section 1B by way of example.

The image forming section 1B includes, in addition to the drum 10B, a charger or charging means 20B, a laser writing device 30 that emits a laser beam LB, a developing unit 40B storing a developing liquid, a discharger or discharging means 50B, a drum cleaning device 60B, which includes a cleaning blade.

The developing unit 40B includes a developing roller or developer carrier 41B. A reservoir or tank 42B stores the developing liquid. A dipping roller 43B is immersed in the developing liquid in the reservoir 42B for dipping up the developing liquid. A metering roller 44B causes the developing liquid dipped up to deposit on the developing roller 41B in the form of a thin layer. The developing liquid is a viscous liquid consisting of a carrier liquid or insulative solvent and toner particles densely dispersed in the carrier liquid.

The intermediate image transferring unit 70 includes an intermediate image transfer body implemented as a belt 100, which is passed over six rollers 71 through 76. The image transferring unit 70 additionally includes four bias rollers for primary image transfer 77B, 77B, 77M and 77C and a belt cleaning device 79 that includes a cleaning blade.

The image transferring device 80 includes a bias roller for secondary image transfer 81 and a power source, not shown, connected to the bias roller 81.

The intermediate image transfer belt 100 and bias rollers 77B through 77C will be described more specifically hereinafter. The belt 100 is passed over the drums 10B through 10C as well as over the rollers 71 through 76 with a preselected degree of tension. The belt 100 is driven to turn counterclockwise, as indicated by an arrow in FIG. 2. The bias roller 77B, for example, faces the drum 10B while nipping the belt 100 between it and the drum 10B. A power source, not shown, applies a preselected bias for primary image transfer to the bias roller 77B, so that the bias roller 77B plays the role of a bias applying electrode at the same time.

The bias roller for secondary image transfer 81 faces the roller 73 and plays the role of a bias applying electrode at the same time. A power source, not shown, applies a preselected bias for secondary image transfer to the bias roller 81.

In operation, while the drum 10B is rotated in a direction indicated by an arrow in FIG. 1, the charger 20B uniformly charges the surface of the drum 10B. The laser beam LB issuing from the laser writing device 30 scans the charged surface of the drum 10B imagewise to thereby form a latent image on the drum 10B. On the other hand, the developing liquid deposited on the dip-up roller 43B in the reservoir 42b is transferred to the developing roller 41B by way of the metering roller 44B. The developing liquid forms a uniform layer as thin as about 0.5 micrometer to 20 micrometers on the developing roller 41B. An electric field transfers the toner contained in the developing liquid from the developing roller 41B to the drum 10B, which is held in contact with the developing roller 41B. The toner develops the latent image formed on the drum 10B for thereby producing a corresponding black toner image.

The drum 10B in rotation conveys the black toner image formed thereon to a primary image transfer position where the drum 10B contacts the belt 10B. A negative bias voltage, which is opposite to positive charge deposited on the toner and may be −300 V to −500 V, is applied to the inner surface of the belt 100 via the bias roller 77B. The resulting electric field causes the toner forming the black toner image on the drum 10B to be attracted toward and transferred to the belt 100 (primary image transfer) In the same manner, a yellow toner image, a magenta toner image and a cyan toner image are sequentially transferred to the belt 100 over the black toner image, completing a full-color image.

A paper sheet P, which is a plain paper sheet, is fed from the paper feeding section, not shown, in a direction indicated by an arrow in FIG. 2. The belt 100 in rotation conveys the full-color image to a secondary image transfer position where the paper sheet P contacts the belt 100. A negative bias voltage, e.g., −800 V to −2,000 V is applied to the rear of the paper sheet P via the bias roller 81. At the same time, the bias roller 81 exerts a pressure of about 50 N/cm² on the paper sheet P. The resulting electric field and the pressure cause the toner on the belt 100 to be attracted toward and collectively transferred to the paper sheet P (secondary image transfer).

A peeler 85 peels off the paper sheet P carrying the full-color image there on from the belt 100. Subsequently, the fixing device 90 fixes the toner image on the paper sheet P. The paper sheet P is then driven out of the copier. After the secondary image transfer, the discharger 50B discharges the drum 10B in order dissipate residual charge. Thereafter, the drum cleaning device 60B removes toner particles left on the drum 10B to thereby prepare the drum 10B for the next image transfer.

The belt 100 has customarily been implemented by an endless, conductive member having preselected thickness and preselected low resistance. For example, the conductive member is 30 micrometers to 150 micrometers thick and formed of a material consisting of, e.g., polyimide, PET (polyethylene terephthalate), PVDF (polyvinylidene fluoride) or similar resin and carbon, metal powder or similar conductive material mixed in a preselected ratio. Such a belt, however, brings about a problem when a toner image is transferred from the belt to, e.g., a plan paper sheet having cavities in its surface. Specifically, because the surface of the belt is hard, it cannot follow the cavities of the plain paper sheet and renders secondary image transfer defective, as stated earlier. Defective secondary image transfer results in irregular image density and other defects.

In the illustrative embodiment, the belt 100 has a surface layer formed of an elastic material in order to closely contact the image surface of, e.g., a plain paper sheet whose surface lacks smoothness. Such a surface layer elastically deforms due to the pressure of the secondary image transfer roller 81 at the time of secondary image transfer. The surface layer can therefore accurately follow the cavities formed by the fibers of the paper sheet.

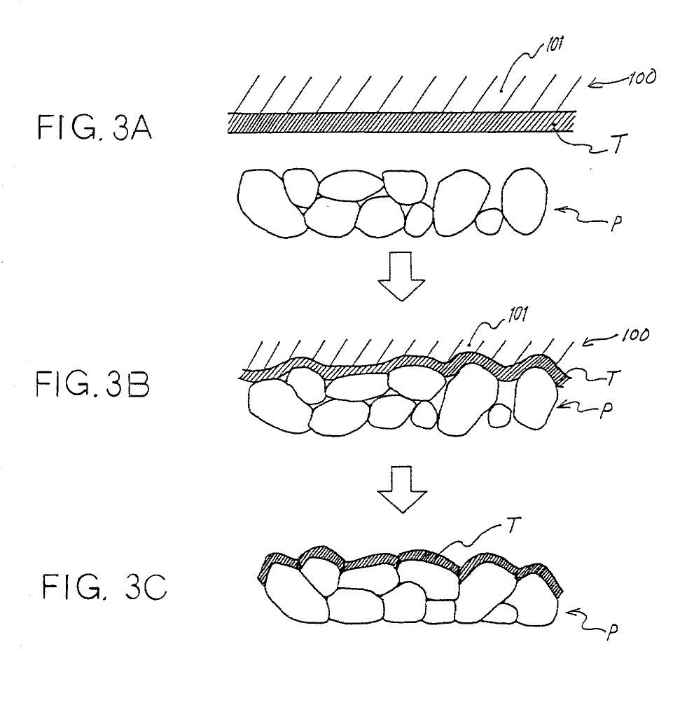

Specifically, FIG. 3A shows the belt 100 with an elastic surface layer 101 and the plain paper sheet P having low surface smoothness. The toner T is deposited on the surface layer 101. As shown in FIG. 3B, the pressure acting between the surface layer 101 and the paper sheet P during secondary image transfer causes the surface layer 101 to elastically deform complementarily to the surface configuration of the paper sheet P. In this condition, the toner T successfully enters the cavities of the paper sheet P. Consequently, the toner T is desirably transferred even to the plain paper sheet P lacking surface smoothness, insuring a high-quality toner image.

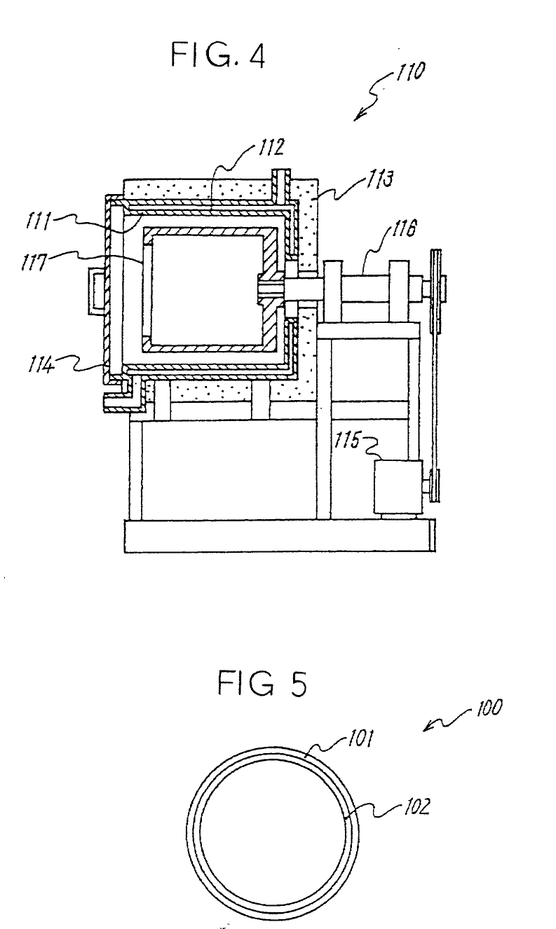

In the illustrative embodiment, the belt 100 having the above-described unique feature is produced by centrifugal molding, as will be described hereinafter. FIG. 4 shows a specific centrifugal molding machine 100. As shown, the machine 100 includes a box-like heating jacket 111 enclosed by a projection vessel 113. The heating jacket 111 has a passage 112 for a heating fluid and has its opening closed by a lid 114. A motor 115 is drivably connected to a rotary shaft 116. One end of the shaft 116 extends into the heating jacket 111 via a side wall opposite to the open side of the jacket 111. The shaft 116 supports a hollow, cylindrical mold 117 on the other end thereof.

To produce the belt 100, the motor 115 causes the shaft 116 and therefore the mold 117 to rotate at a speed of about 1,000 rpm (revolutions per minute). At the same time, thermosetting urethane rubber and a crosslinking agent are fed into the mold 117 as a raw liquid material for forming the surface layer 101. The mold 117 is continuously rotated for about 10 minutes in order to cause the above liquid to form a uniform layer on the inside of the mold 117 by a centrifugal force. Subsequently, the mold 117 is heated to about 140° at which crosslinking occurs in thermosetting urethane rubber, and maintained at the above temperature for about 1 hour, thereby curing thermosetting urethane rubber. The mold 117 is then cooled off to a temperature at which crosslinking does not occur in the raw material (around room temperature).

Subsequently, while the mold 117 is rotated without the surface layer 101 being removed therefrom, thermosetting urethane resin and a crosslinking agent are fed into the mold 117 as a raw liquid material for forming a base layer 102 (see FIG. 5). After the mold 117 has been rotated for about 10 minutes, it is again heated to about 140° and held thereat for about 1 hour. Thereafter, when the resin layer is fully cured, the mold 117 is cooled off. After the operation of the machine 110 has been stopped, the belt made up of the base layer 102 and surface layer 101 is removed from the mold 117.

In the centrifugal molding machine 110, the smoothness of the inside of the mold 117 directly translates into the smoothness of the surface of the belt 100. Therefore, to provide the belt 100 with a desirably smooth surface, it is necessary to increase the smoothness of the inside of the mold 117. As for an index representative of the smoothness of the inside of the mold 117, use may be made of a ten-point means roughness Rz in accordance with JIS (Japanese Industrial Standards). To implement the desired surface smoothness of the belt 100, the in side of the mold 117 should preferably have smoothness corresponding to a ten-point mean roughness of 1 micrometer or below.

Another index available for the above smoothness is a gloss value. The inside of the mold 117 should preferably have a gloss value of 80 or above. Such a gloss value provides the surface of the belt 100 with a gloss value of at least 50, which is representative of desirable surface smoothness. A glossmeter Type PG-3D available from Nippon Denshoku was used to measure gloss values.

FIG. 5 is a side elevation showing the belt 100 produced by the centrifugal molding machine 110 and made up of the surface layer 101 and base layer 102. The surface layer 101 had rubber hardness of 50°, as measured by JIS A scale, after crosslinking and thickness of 400 micrometers. The base layer 102 had a Young's module of about 750 MPa and thickness of 100 micrometers. The belt 100 therefore had overall thickness of 500 micrometers. Also, the belt 100 had surface roughness Rz of about 0.7 micrometer. The thickness of the surface layer 101 and that of the base layer 102 each can be controlled in terms of the amount of the respective raw liquid material to be fed into the mold 117.

The material of the surface layer 101 and that of the base layer 102 should preferably belong to the same series, so that the two layers 101 and 102 can be closely bonded to each other and can be uniform each. Should the materials of the layers 101 and 102 be noticeably different from each other, the layers 101 and 102 might be prevented from being closely bonded to each other. Further, the hardness of each material should preferably vary from the rubber range to the resin range in accordance with the composition. This is why the surface layer 101 and base layer 102 are respectively implemented by an urethane rubber layer derived from thermosetting polyurethane rubber and an urethane layer derived from thermosetting polyurethane resin.

If desired, the base layer 102 may be formed before the surface layer 101 is fully cured, as follows. While the mold 117 is in rotation, the raw liquid material for forming the surface layer 101 is fed into the mold 117 in order to form a uniform layer due to a centrifugal force, as stated earlier. Subsequently, before crosslinking fully occurs in the above raw material, the raw liquid material for forming the base layer 102 is fed into the mold 117. Finally, the two raw liquid materials are fully cured together. Such an alternative procedure is successful to reduce the production time and therefore to enhance the efficient production of the belt 100.

Further, the belt 100 may additionally include a third layer, e.g., a rubber layer having a good gripping characteristic, which increases friction between the belt 100 and a belt drive roller not shown. Such an additional layer or layers can be formed by repeating the procedure described above.

The raw liquid materials described above are only illustrative and may be replaced with any other suitable thermosetting resins and rubbers or even with thermoplastic resins and rubbers or resins and rubbers that are soluble in solvents. Typical of such resins are polycarbonate, polyester, polyamide, polyimide, polyamideimide, polyalkylene terephthalate (polyethylene terephthalate or polybuthyl terephthalate), polyolefine and polysulfone. Also, typical of rubbers for the above application are nitrile rubber, buthyl rubber, polyurethane, polyurea, acrylic rubber, hydrine rubber, chloroprene rubber, fluororubber, ethylene-propylene rubber, isoprene rubber, silicone rubber (e.g. polydimethyl-silicone rubber or fluorosilicone rubber) or thermoplastic elastomers. If desired, such raw materials may be combined in order to implement other various raw materials feasible for the above application.

To provide the belt 100 with a preselected electric characteristic, carbon black, tin oxide, titanium oxide or similar powder is mixed with the above-described raw materials.

The prerequisite with the surface layer 101 is that it is elastic enough to accurately follow and closely contact the irregular surface of the plain paper sheet P. The surface layer 101 should preferably have hardness between 30° and 70°, more preferably between 40° and 60°, as measured in JIS A scale.

The softer the surface layer 101, the more closely the surface layer 101 contacts the plain paper sheet P at the time of secondary image transfer. However, when rubber having low hardness is used for the surface layer 101, rubber hardness lower than 40° causes tack to occur on the surface of the layer 101. It is therefore likely that much toner particles remain on the belt 100 after the secondary image transfer. This not only makes the secondary image transfer defective, but also makes it difficult to remove the residual toner particles from the belt 100. Moreover, it is difficult with the state-of-the-art technology to produce the surface layer 101 having low hardness. The surface layer 101 whose hardness is between 40° and 60° is easiest to produce and suffers from tack little. The hardness of the surface layer 101 above 60° would prevent the layer 101 from closely contacting the plain paper sheet P and would thereby bring about defective image transfer.

As for the surface layer 101, not only hardness but also thickness is important. The thickness of the surface layer 101 should preferably be between 50 micrometers and 2,000 micrometers, more preferably 200 micrometers and 600 micrometers. Thickness below 50 micrometers would prevent the surface layer 101 from sufficiently closely contacting the plain paper sheet P. On the other hand, thickness above 2,000 micrometers would cause the surface of the belt 100, which are passed over the rollers 71 through 76, to noticeably expand and contract. This would cause the surface of the belt 100 to crack or cause a toner image to be distorted. Moreover, thickness above 2,000 micrometers is not achievable without resorting to a greater amount of raw liquid material, which would increase the feeding and curing time and therefore the production cost.

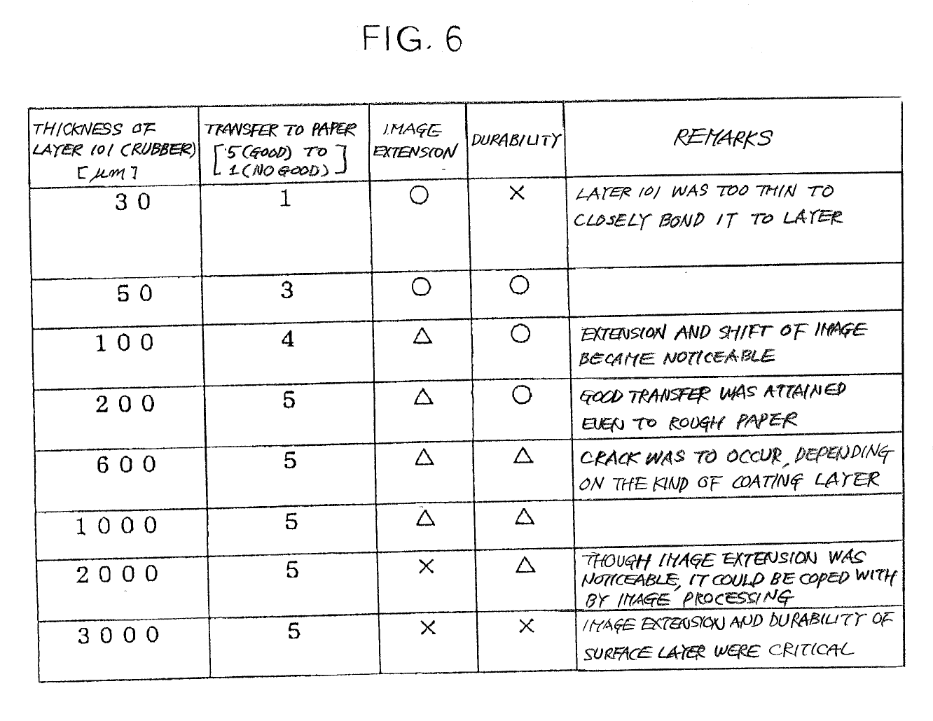

FIG. 6 shows the results of experiments conducted to determine a relation between the thickness of the surface layer 101, which was formed of rubber, and some different estimation factors including an image transfer characteristic. As FIG. 6 indicates, the practicable range of the thickness is between 50 micrometers and 2,000 micrometers, more preferably 200 micrometers and 600 micrometers. While the thickness of 2,000 micrometers causes an image to noticeably extend, the extension can be fully coped with by, e.g., image processing.

The material of the belt 100 should not extend in the circumferential direction of the belt 100, so that the base layer 102 should not have flexibility. To meet this requirement, the base layer 102 is provided with greater hardness than the surface layer 101. The base layer 102 does not extend in the circumferential direction if it has hardness of at least 75°, as measured in JIS A scale, and certain thickness (around 500 micrometers)

When the base layer 102 is formed of resin, the base layer 102 can have sufficient strength even if it is relatively thin, because of the inherently high Young's modulus. ETFE (ethylene-tetrafluoroethylene copolymer), which is a specific fluorocarbon resin customarily used for an intermediate image transfer belt, has a Young's modulus of about 450 MPa and thickness ranging from 100 micrometers to 150 micrometers. By contrast, when the base layer 102 is about 300 micrometers thick, it achieves strength comparable with that of the above material if its Young's modulus is only about 200 MPa. In practice, because the belt 100 should preferably be thin, the thickness of the base layer or resin layer 102 can be reduced to about 50 micrometers if the Young's module is 1,000 MPa or above. However, a Young's module above 3,000 MPa is likely to cause the base layer 102 to break. It is therefore preferable to confine the Young's modulus of the base layer 102 in a range of from 200 MPa and 3,000 MPa.

The thickness of the base layer 102 should preferably be between 30 micrometers and 1,000 micrometers, more preferably 50 micrometers and 150 micrometers.

Generally, the minimum uniform thickness available with centrifugal molding is about 30 micrometers. The thickness of the base layer 102 smaller than 30 micrometers would increase the cost. The base layer 102 should be as thin as possible in order to free the belt 100 from curl and other problems. In practice, however, the minimum thickness is about 50 micrometers; 100 micrometers to 150 micrometers insure stable production of the base layer 102.

Assume that the belt 100 needs strength, but only a material having a small Young's modulus is applicable to the base layer 102. Then, the only way available is to increase the thickness of the base layer 102 for thereby increasing the overall strength of the belt 100. However, the thickness of the base layer 102 exceeding the above range makes it mechanically difficult to deal with the belt 100. For example, such thickness prevents the rotation speed of a drive roller contacting the inner surface of the belt 100 and the moving speed of the surface of the belt 100 from coinciding with each other. Moreover, the thickness exceeding the above range causes the surface of the surface layer 101 to noticeably expand and contract, causing the surface layer 101 to crack or a toner image to be distorted.

It is to be noted that the belt 100 of the illustrative embodiment enhances desirable image transfer when applied to, among others, an electrophotographic image forming apparatus using liquid toner, which is difficult to transfer in dependence on the surface roughness or irregularity of a plain paper sheet.

In summary, it will be seen that the present invention provides an image forming apparatus, an intermediate image transfer belt therefor and a method of producing the belt having various unprecedented advantages, as enumerated below.

(1) A first layer, which constitutes the front surface of the belt, accurately follows the surface of a recording medium while elastically deforming. The belt therefore insures desirable image transfer even with a plain paper sheet or similar recording medium lacking surface smoothness. A second layer, which constitutes the rear surface of the belt, is not flexible and not extendible in the circumferential direction.

(2) The belt can be produced in a short period of time and therefore with high efficiency.

(3) The belt can be implemented as a laminate having any desired characteristic.

(4) Sophisticated processing is not necessary for the first layer to have elasticity or for the second layer to have greater hardness than the first layer. The belt therefore achieves desirable image transfer only if materials are adequately selected.

(5) The first and second layers are closely bonded to each other, providing the belt with uniform thickness.

(6) The belt is free from defective image transfer and defective cleaning ascribable to tack and the deterioration of the close bond.

(7) Damage to the surface of the belt and the deformation of a toner image ascribable to the expansion and contraction of the above surface are obviated. In addition, the belt is low cost.

(8) The first layer can be formed of urethane rubber having hardness that lies in a broad range.

(9) The belt is free from folding and other damage as well as from expansion and contraction, protecting toner images from distortion.

(10) The surface of the belt is smooth enough to insure desirable image transfer.

Various modifications will become possible for those skilled in the art after receiving the teachings of the present disclosure without departing from the scope thereof.

What is claimed is:

1. A method of producing an intermediate image transfer belt for an image forming apparatus that includes an image carrier for forming a latent image, a developing device for developing said latent image with a developer to thereby form a corresponding toner image and said intermediate image transfer belt to which said toner image is transferred from said image carrier, and executes primary image transfer from said image carrier to said intermediate image transfer belt and then executes secondary image transfer from said intermediate image transfer belt to a recording medium, said method comprising the steps of:
feeding a first raw liquid material into a hollow, cylindrical mold, which is included in a centrifugal molding machine, while causing said mold to rotate;
curing the first raw material to thereby form a first endless belt layer on an inside of the mold;
feeding a second raw liquid material into the mold while causing said mold to rotate; and
curing said second raw liquid to thereby form a second belt layer;
wherein said first belt layer has elasticity while said second belt layer has greater hardness than said first belt layer.

2. The method as claimed in claim 1, further comprising the step of forming a third belt layer different in material from said first layer and said second layer on said second layer.

3. The method as claimed in claim 2, wherein the first raw liquid material provides said first belt layer with elasticity after curing while the second raw liquid material provides said second belt layer with hardness greater than hardness of said first belt layer after curing.

4. The method as claimed in claim 3, wherein said first belt layer and said second belt layer have a same major composition except for hardness.

5. The method as claimed in claim 4, wherein said first belt layer has hardness ranging from 30° to 70°, as measured by JIS A scale.

6. The method as claimed in claim 5, wherein said first belt layer has thickness ranging from 50 micrometers to 2,000 micrometers.

7. The method as claimed in claim 6, wherein the first raw liquid material comprises thermosetting polyurethane rubber.

8. The method as claimed in claim 7, wherein said second belt layer has hardness of 75° or above, as measured by JIS A scale.

9. The method as claimed in claim 8, wherein said second belt layer has a Young's module ranging from 200 MPa to 3,000 MPa.

10. The method as claimed in claim 9, wherein said second belt layer has thickness ranging from 30 micrometers to 1,000 micrometers.

11. The method as claimed in claim 10, wherein the second raw liquid material comprises thermosetting polyurethane resin.

12. The method as claimed in claim 11, wherein the inside of the mold has smoothness of 1 micrometer or less in terms of a ten-point mean roughness (JIS).

13. The method as claimed in claim 12, wherein the inside of the mold has a gloss value of 80 or above.

14. The method as claimed in claim 1, wherein the first raw liquid material provides said first belt layer with elasticity after curing while the second raw liquid material provides said second belt layer with hardness greater than hardness of said first belt layer after curing.

15. The method as claimed in claim 1, wherein said first belt layer and said second belt layer have a same major composition except for hardness.

16. The method as claimed in claim 1, wherein said first belt layer has hardness ranging from 30° to 70°, as measured by JIS A scale.

17. The method as claimed in claim 1, wherein said first belt layer has thickness ranging from 50 micrometers to 2,000 micrometers.

18. The method as claimed in claim 1, wherein the first raw liquid material comprises thermosetting polyurethane rubber.

19. The method as claimed in claim 1, wherein said second belt layer has hardness of 75° or above, as measured by JIS A scale.

20. The method as claimed in claim 1, wherein said second belt layer has a Young's module ranging from 200 MPa to 3,000 MPa.

21. The method as claimed in claim 1, wherein said second belt layer has thickness ranging from 30 micrometers to 1,000 micrometers.

22. The method as claimed in claim 1, wherein the second raw liquid material comprises thermosetting polyurethane resin.

23. The method as claimed in claim 1, wherein the inside of the mold has smoothness of 1 micrometer or less in terms of a ten-point mean roughness (JIS).

24. The method as claimed in claim 1, wherein the inside of said mold has a gloss value of 80 or above.

25. A method of producing an intermediate image transfer belt for an image forming apparatus that includes an image carrier for forming a latent image, a developing device for developing said latent image with a developer to thereby form a corresponding toner image and said intermediate image transfer belt to which said toner image is transferred from said image carrier, and executes primary image transfer from said image carrier to said intermediate image transfer belt and then executes secondary image transfer from said intermediate image transfer belt to a recording medium, said method comprising the steps of:
feeding a first raw liquid material into a hollow, cylindrical mold, which is included in a centrifugal molding machine, while causing said mold to rotate to thereby form an endless first film on an inside of said mold;
feeding a second raw liquid material into the inside of the mold while causing said mold to rotate to thereby form a second film on said first film; and
curing the raw liquid materials respectively forming said first film and said second film;
wherein said first film forms, when cured, an elastic, first belt layer while said second forms, when cured, a second belt layer having greater hardness than said first belt layer.

26. The method as claimed in claim 25, further comprising the step of forming a third belt layer different in material from said first layer and said second layer on said second layer.

27. The method as claimed in claim 26, wherein the first raw liquid material provides said first belt layer with elasticity after curing while the second raw liquid material provides said second belt layer with hardness greater than hardness of said first belt layer after curing.

28. The method as claimed in claim 27, wherein said first belt layer and said second belt layer have a same major composition except for hardness.

29. The method as claimed in claim 27, wherein said first belt layer has hardness ranging from 30° to 70°, as measured by JIS A scale.

30. The method as claimed in claim 29, wherein said first belt layer has thickness ranging from 50 micrometers to 2,000 micrometers.

31. The method as claimed in claim 30, wherein the first raw liquid material comprises thermosetting polyurethane rubber.

32. The method as claimed in claim 31, wherein said second belt layer has hardness of 75° or above, as measured by JIS A scale.

33. The method as claimed in claim 32, wherein said second belt layer has a Young's module ranging from 200 MPa to 3,000 MPa.

34. The method as claimed in claim 33, wherein said second belt layer has thickness ranging from 30 micrometers to 1,000 micrometers.

35. The method as claimed in claim 34, wherein the second raw liquid material comprises thermosetting polyurethane resin.

36. The method as claimed in claim 35, wherein the inside of the mold has smoothness of 1 micrometer or less in terms of a ten-point mean roughness (JIS).

37. The method as claimed in claim 36, wherein the inside of the mold has a gloss value of 80 or above.

38. The method as claimed in claim 25, wherein the first raw liquid material provides said first belt layer with elasticity after curing while the second raw liquid material provides said second belt layer with hardness greater than hardness of said first belt layer after curing.

39. The method as claimed in claim 25, wherein said first belt layer and said second belt layer have a same major composition except for hardness.

40. The method as claimed in claim 25, wherein said first belt layer has hardness ranging from 30° to 70°, as measured by JIS A scale.

41. The method as claimed in claim 25 wherein said first belt layer has thickness ranging from 50 micrometers to 2,000 micrometers.

42. The method as claimed in claim 25, wherein the first raw liquid material comprises thermosetting polyurethane rubber.

43. The method as claimed in claim 25, wherein said second belt layer has hardness of 75° or above, as measured by JIS A scale.

44. The method as claimed in claim 25, wherein said second belt layer has a Young's module ranging from 200 MPa to 3,000 MPa.

45. The method as claimed in claim 25, wherein said second belt layer has thickness ranging from 30 micrometers to 1,000 micrometers.

46. The method as claimed in claim 25, wherein the second raw liquid material comprises thermosetting polyurethane resin.

47. The method as claimed in claim 25, wherein an inner surface of said mold has smoothness of 1 micrometer or less in terms of a ten-point mean roughness (JIS).

48. The method as claimed in claim 25, wherein the inner surface of said mold has a gloss value of 80 or above.

49. In an intermediate image transfer belt for an image forming apparatus that includes an image carrier for forming a latent image, a developing device for developing said latent image with a developer to thereby form a corresponding toner image and said intermediate image transfer belt to which said toner image is transferred from said image carrier, and executes primary image transfer from said image carrier to said intermediate image transfer belt and then executes secondary image transfer from said intermediate image transfer belt to a recording medium,
a first raw liquid material is fed into a hollow, cylindrical mold, which is included in a centrifugal molding machine, with said mold being rotated;
the first raw material is cured to thereby form a first endless belt layer on an inside of the mold;
a second raw liquid material is fed into the mold with said mold being rotated, and then cured to thereby form a second belt layer; and
said first belt layer has elasticity while said second belt layer has greater hardness than said first belt layer.

50. The belt as claimed in claim 49, wherein a third belt layer different in material from said first layer and said second layer is formed on said second layer.

51. The belt as claimed in claim 50, wherein the first raw liquid material provides said first belt layer with elasticity after curing while the second raw liquid material provides said second belt layer with hardness greater than hardness of said first belt layer after curing.

52. The belt as claimed in claim 51, wherein said first belt layer and said second belt layer have a same major composition except for hardness.

53. The belt as claimed in claim 52, wherein said first belt layer has hardness ranging from 30° to 70°, as measured by JIS A scale.

54. The belt as claimed in claim 53, wherein said first belt layer has thickness ranging from 50 micrometers to 2,000 micrometers.

55. The belt as claimed in claim 54, wherein the first raw liquid material comprises thermosetting polyurethane rubber.

56. The belt as claimed in claim 55, wherein said second belt layer has hardness of 75° or above, as measured by JIS A scale.

57. The belt as claimed in claim 56, wherein said second belt layer has a Young's module ranging from 200 MPa to 3,000 MPa.

58. The belt as claimed in claim 57, wherein said second belt layer has thickness ranging from 30 micrometers to 1,000 micrometers.

59. The belt as claimed in claim 58, wherein the second raw liquid material comprises thermosetting polyurethane resin.

60. The belt as claimed in claim 59, wherein the inside of the mold has smoothness of 1 micrometer or less in terms of a ten-point mean roughness (JIS).

61. The belt as claimed in claim 60, wherein the inside of the mold has a gloss value of 80 or above.

62. The belt as claimed in claim 49, wherein the first raw liquid material provides said first belt layer with elasticity after curing while the second raw liquid material provides said second belt layer with hardness greater than hardness of said first belt layer after curing.

63. The belt as claimed in claim 49, wherein said first belt layer and said second belt layer have a same major composition except for hardness.

64. The belt as claimed in claim 49, wherein said first belt layer has hardness ranging from 30° to 70°, as measured by JIS A scale.

65. The belt as claimed in claim 49, wherein said first belt layer has thickness ranging from 50 micrometers to 2,000 micrometers.

66. The belt as claimed in claim 49, wherein the first raw liquid material comprises thermosetting polyurethane rubber.

67. The belt as claimed in claim 49, wherein said second belt layer has hardness of 75° or above, as measured by JIS A scale.

68. The belt as claimed in claim 49, wherein said second belt layer has a Young's module ranging from 200 MPa to 3,000 MPa.

69. The belt as claimed in claim 49, wherein said second belt layer has thickness ranging from 30 micrometers to 1,000 micrometers.

70. The belt as claimed in claim 49, wherein the second raw liquid material comprises thermosetting polyurethane resin.

71. The belt as claimed in claim 49, wherein the inside of the mold has smoothness of 1 micrometer or less in terms of a ten-point mean roughness (JIS).

72. The belt as claimed in claim 49, wherein the inside of the mold has a gloss value of 80 or above.

73. In an intermediate image transfer belt for an image forming apparatus that includes an image carrier for forming a latent image, a developing device for developing said latent image with a developer to thereby form a corresponding toner image and said intermediate image transfer belt to which said toner image is transferred from said image carrier, and executes primary image transfer from said image carrier to said intermediate image transfer belt and then executes secondary image transfer from said intermediate image transfer belt to a recording medium, said method comprising the steps of:
a first raw liquid material is fed into a hollow, cylindrical mold, which is included in a centrifugal molding machine, with said mold being rotated to thereby form an endless first film on an inner surface of said mold;
a second raw liquid material is fed into the mold with said mold being rotated to thereby form a second film on said first film;
the raw liquid materials respectively forming said first film and said second film are cured; and
said first film forms, when cured, an elastic, first belt layer while said second forms, when cured, a second belt layer having greater hardness than said first belt layer.

74. The belt as claimed in claim 73, wherein a third belt layer different in material from said first belt layer and said second belt layer is formed on said second belt layer.

75. The belt as claimed in claim 74, wherein the first raw liquid material provides said first belt layer with elasticity after curing while the second raw liquid material provides said second belt layer with hardness greater than hardness of said first belt layer after curing.

76. The belt as claimed in claim 75, wherein said first belt layer and said second belt layer have a same major composition except for hardness.

77. The belt as claimed in claim 76, wherein said first belt layer has hardness ranging from 30° to 70°, as measured by JIS A scale.

78. The belt as claimed in claim 77, wherein said first belt layer has thickness ranging from 50 micrometers to 2,000 micrometers.

79. The belt as claimed in claim 78, wherein the first raw liquid material comprises thermosetting polyurethane rubber.

80. The belt as claimed in claim 79, wherein said second belt layer has hardness of 75° or above, as measured by JIS A scale.

81. The belt as claimed in claim 80, wherein said second belt layer has a Young's module ranging from 200 MPa to 3,000 MPa.

82. The belt as claimed in claim 81, wherein said second belt layer has thickness ranging from 30 micrometers to 1,000 micrometers.

83. The belt as claimed in claim 82, wherein the second raw liquid material comprises thermosetting polyurethane resin.

84. The belt as claimed in claim 83, wherein the inside of the mold has smoothness of 1 micrometer or less in terms of a ten-point mean roughness (JIS).

85. The belt as claimed in claim 84, wherein the inside of the mold has a gloss value of 80 or above.

86. The belt as claimed in claim 73, wherein the first raw liquid material provides said first belt layer with elasticity after curing while the second raw liquid material provides said second belt layer with hardness greater than hardness of said first belt layer after curing.

87. The belt as claimed in claim 73, wherein said first belt layer and said second belt layer have a same major composition except for hardness.

88. The belt as claimed in claim 73, wherein said first belt layer has hardness ranging from 30° to 70°, as measured by JIS A scale.

89. The belt as claimed in claim 73, wherein said first belt layer has thickness ranging from 50 micrometers to 2,000 micrometers.

90. The belt as claimed in claim 73, wherein the first raw liquid material comprises thermosetting polyurethane rubber.

91. The belt as claimed in claim 73, wherein said second belt layer has hardness of 75° or above, as measured by JIS A scale.

92. The belt as claimed in claim 73, wherein said second belt layer has a Young's module ranging from 200 MPa to 3,000 MPa.

93. The belt as claimed in claim 73, wherein said second belt layer has thickness ranging from 30 micrometers to 1,000 micrometers.

94. The belt as claimed in claim 73, wherein the second raw liquid material comprises thermosetting polyurethane resin.

95. The belt as claimed in claim 73, wherein the inside of the mold has smoothness of 1 micrometer or less in terms of a ten-point mean roughness (JIS).

96. The belt as claimed in claim 73, wherein the inside of the mold has a gloss value of 80 or above.

97. An image forming apparatus comprising:
an image carrier for forming a latent image;
a developing device for developing the latent image with a developer to thereby form a corresponding toner image; and
an intermediate image transfer body to which the toner image is transferred from said image carrier, said intermediate image transfer body constituting an intermediate image transfer belt for executing primary image transfer from said image carrier to said intermediate image transfer belt and then executing secondary image transfer from said intermediate image transfer belt to a recording medium;
wherein a first raw liquid material is fed into a hollow, cylindrical mold, which is included in a centrifugal molding machine, with said mold being rotated;
the first raw material is cured to thereby form a first endless belt layer on an inside of the mold;
a second raw liquid material is fed into the mold with said mold being rotated, and then cured to thereby form a second belt layer; and
said first belt layer has elasticity while said second belt layer has greater hardness than said first belt layer.

98. An image forming apparatus comprising:
an image carrier for forming a latent image;
a developing device for developing the latent image with a developer to thereby form a corresponding toner image; and
an intermediate image transfer body to which the toner image is transferred from said image carrier, said intermediate image transfer body constituting an intermediate image transfer belt for executing primary image transfer from said image carrier to said intermediate image transfer belt and then executing secondary image transfer from said intermediate image transfer belt to a recording medium;
wherein a first raw liquid material is fed into a hollow, cylindrical mold, which is included in a centrifugal molding machine, with said mold being rotated to thereby form an endless first film on an inside of said mold;
a second raw liquid material is fed into the mold with said mold being rotated to thereby for a second film on said first film;
the raw liquid materials respectively forming said first film and said second film are then cured; and
said first film forms, when cured, an elastic, first belt layer while said second forms, when cured, a second belt layer having greater hardness than said first belt layer.
